(19) United States
(12) Patent Application Publication
(10) Pub. No.: US 2020/0186423 A1
(43) Pub. Date: Jun. 11, 2020

(54) INTELLIGENT NODE FACEPLATE AND SERVER RACK MAPPING

(71) Applicant: Nutanix, Inc., San Jose, CA (US)

(72) Inventors: John Torres, San Jsoe, CA (US); Ken Chen, San Francisco, CA (US); Melina Susanne McLarty, Aptos, CA (US); Jason L. Klein, Mountain View, CA (US); Ricky Koo, Los Altos, CA (US); Shamanth Kengeri Padamaraj, Bangalore (IN)

(73) Assignee: Nutanix, Inc., San Jose, CA (US)

(21) Appl. No.: 16/211,054

(22) Filed: Dec. 5, 2018

(51) Int. Cl. H04L 12/24; G06F 9/455

(52) U.S. Cl. CPC H04L 41/0866; H04Q 1/04; G06F 2009/45595; G06F 9/45558

(57) ABSTRACT

An apparatus for computing node mapping within a server rack, and a method therefore, are discussed. The apparatus includes a processor configured to control a transceiver to receive a request to register computing nodes installed in a server rack; provide, in response to determining that a scan of a respective node tag of a computing node of the computing nodes installed in a server rack is different than a particular order, an alert indicating an out of order scan; add, in response to determining that the scan of the respective node tag of the computing node complies with the particular order, respective node information received via the respective node tag to server rack node information; and after completing the iterative scan of the respective node tags of the computing nodes installed in the server rack, provide the server rack node information to the administrator system.

### TECHNICAL FIELD

Examples described herein relate to server rack maintenance for virtualized and/or distributed computing systems. Examples of managing server rack computing node configuration in the system are described.

### BACKGROUND

A virtual machine (VM) generally refers to a software-based implementation of a machine in a virtualization environment, in which the hardware resources of a physical computer (e.g., CPU, memory, etc.) are virtualized or transformed into the underlying support for the fully functional VM that can run its own operating system and applications on the underlying physical resources just like a real computer.

Virtualization generally works by inserting a thin layer of software directly on the computer hardware or on a host operating system. This layer of software contains a VM monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a VM may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by VMs. Virtualization allows multiple VMs to share the underlying physical resources so that during periods of inactivity by one VM, other VMs can take advantage of the resource availability to process workloads. However, in some examples, environment characteristics or physical configurations of the server rack of the computing nodes may negatively affect system performance of computing nodes in the server rack used for hosting the VMs. The physical configurations of the computing nodes in the server rack, including physical locations of the computing nodes, may be changed over time during performance of regular system maintenance, equipment upgrades, or faulty equipment replacement. As a result of the changes to the physical locations of the computing nodes, virtualized computing node tags for VMs hosted by the computing blocks may become out of date or inaccurate.

Configuration changes or troubleshooting reported issues associated with the computing nodes may be difficult due to the node tags inaccurate node location information.

### BRIEF DESCRIPTION OF THE DRAWINGS

FIG. 1 is a block diagram of a computing system in accordance with embodiments described herein.

FIG. 2 is a block diagram of a computing system in accordance with embodiments described herein.

FIG. 3 is a mobile device and a computing node of a computing system in accordance with embodiments described herein.

FIG. 4 is an illustration of a mobile device of a computing system in accordance with embodiments described herein.

FIG. 5 is a flow diagram of a method for computing node registration and mapping relative location within a server rack in accordance with embodiments described herein.

FIG. 6 is a flow diagram of a method for computing node registration and mapping within a server rack in accordance with embodiments described herein.

### DETAILED DESCRIPTION OF PREFERRED EMBODIMENTS

Certain details are set forth herein to provide an understanding of described embodiments of technology. However, other examples may be practiced without various of these particular details. In some instances, well-known virtualized and/or distributed computing system components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Generally, a mobile device may include a companion application that interacts (e.g., communicates with) with a smart host faceplate of a computing node. The computing node may be installed in a server rack. The communication between the mobile device and the smart host faceplate may be via radio-frequency identification (RFID), near-field communication (NFC), scan of a QR code, Bluetooth, or any other short-range communication technology. In some examples, the smart host faceplate may include an NFC device that may be encoded with node data, such as node identification data, status data, configuration data, or combinations thereof. The node data may be received at the mobile device, and a user interface of the mobile device may provide a prompt for a user to accept received node data from the NFC device.

In some examples, the mobile companion application may provide a process for mapping relative positions of computing nodes installed in a server rack. For example, the mobile companion may provide prompts to a user to retrieve (e.g., via a tap, scan, etc.) respective node data from the smart host faceplates of computing nodes installed in the server rack. In some examples, the process may include retrieval of the respective node information in a particular order, such as a top-to-bottom computing node scan, a bottom-to-top computing node scan, a right-to-left computing node scan, a left-to-right computing node scan, or any combination thereof. In some examples, relative position of the computing nodes installed in a computing node rack may be determined by the mobile device based on a relative position of the mobile device for each scan as compared with a previous scan. A position of the mobile device relative to a previous scan may be determined using movement information, such as movement information received via an internal accelerometer data (e.g., referential positioning data) of the mobile device. In some examples, the received node data may be store locally in response to acceptance. In some examples, the relative position information of the mobile device may be stored with the respective node data. The relative position data may be used to determine a map of the computing node layout of a server rack. In some examples, the map of the server rack may be expanded to include relative location among other server racks, and the position information may include other position information, such as global position system information.

The map of the server rack may allow a user to more efficiently troubleshoot issues with the server rack. In some examples, the mobile companion application running on the mobile device may allow a user to retrieve status information of a computing node, such as configuration information, health, etc.

In some examples, the smart host faceplates may each include visual indicators (e.g., lights, such as light-emitting diode (LED) lights, 7-segment displays, and/or other types of displays), that are configured to provide node information related to status of the computing node to a user, such as configuration or health information. The information may be communicated via light patterns (e.g., on/off and/or different colors), alpha-numerical characters, or combinations thereof. In some examples, the visual indicators may be provided responsive to proximity of the mobile device to the smart host faceplate. The mobile application may provide tools for a user to perform a variety of operations, while the visual indicators provide feedback on status of the operations.

The mobile device may be used to execute a rolling upgrade across computing nodes of the server rack. The mobile device and/or the server rack may display a visual indications of the upgrade status corresponding to computing nodes being upgraded.

The computing nodes of the server rack may automatically or autonomously display information, or be controlled by the mobile device to display information. The mobile device may include hardware to provide node information to an administrator system regarding physical locations of computing nodes relative to other computing nodes.

In some examples, if the computing node is experiencing an issue, the application may cause suggested actions to be taken to be displayed on the mobile device. In addition, the application may also cause a cause of a failure to be displayed. In some examples, the mobile device may be capable of, either directly or via the administrative system, shutting down a computing node, putting a computing node in a maintenance mode, disabling a networking connection, etc., or combinations thereof.

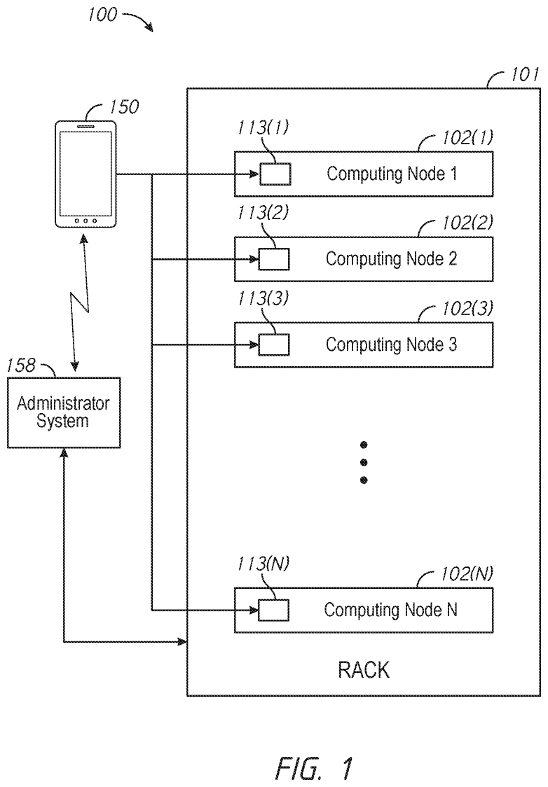

FIG. 1 is a block diagram of a computing system 100 arranged in accordance with examples described herein. The computing system may include a server rack 101, a mobile device 150, and an administrator system 158. The mobile device 150 may communicate with the administrator system 158 via a wireless network, or a combination of a wireless and wired network. The administrative system may communicate with the server rack 101 and the computing nodes 102(1)-(N) via a network, such as wired, wireless, or combinations thereof. The server rack 101 includes computing nodes 102(1)-102(N) and node tags 113(1)-113(N). The computing nodes 102(1)-102(N) may include a server computer, a laptop computer, a desktop computer, a tablet computer, a smart phone, or any other type of computing device capable of being installed in the server rack 101. While the server rack 101 is depicted with at least four of the computing nodes 102(1)-102(N), more or fewer of the computing nodes 102(1)-102(N) may be included in the server rack without departing from the scope of the disclosure.

In operation, the mobile device 150 may retrieve node data from the computing nodes via the node tags 113(1)-(N). The mobile device 150 may receive node data from a computing node of the computing nodes 102(1)-102(N) by tapping the mobile device 150 near one of the respective node tags 113(1)-113(N), scanning the respective node tags 113(1)-113(N), initiating an RFID communication pairing with the respective node tags 113(1)-113(N), etc. The node data may include a node identifier. In some examples, the node data may further include alerts, status information, configuration information, etc., or combinations thereof.

In one example, retrieval of the node data by the mobile device 150 may be to facilitate mapping of physical locations of the computing nodes 102(1)-102(N) relative to one another within the server rack 101. The mobile device 150 may provide prompts and/or instructions to a user to retrieve node data associated with each of the computing nodes 102(1)-102(N). The mobile device 150 may retrieve node data from the node tags 113(1)-113(N) of computing nodes 102(1)-102(N). In some examples, an order in which the node data is retrieved from the computing nodes 102(1)-102(N) may be specified (e.g., via instructions or a prompt displayed on the mobile phone 150), predetermined (e.g., based on a previous order), or may be based on some other criteria. The order may include a top-to-bottom scan, a bottom-to-top scan, a right-to-left scan, a left-to-right scan, or any combination thereof. When node data is retrieved from the computing nodes 102(1)-102(N) in an order that is different than an expected order, the mobile device 150 may provide an alert indicating an out-of-order scan. In response to determining that node data retrieved from the respective node tag 113(1)-113(N) of the computing node 102(1)-102(N) complies with the particular order, the mobile device 150 may add the respective node data received via the respective node tag 113(1)-113(N) to server rack node information. The server rack node information may be provided to the administrator system 158 by the mobile phone 150, either after every scan, or collectively after a scan of all of the computing nodes 102(1)-(N) is complete. The mobile device 150 may detect an out-of-order scan using internal accelerometer data to determine a direction of movement between scans. Thus, if the order is vertically from top-to-bottom, the mobile device 150 may determine whether each scan is executed after vertical downward movement using the accelerometer data. If upward movement is detected, the mobile device 150 may provide an alert and/or direct the user to restart the scan. Other movement patterns may be detected without departing from the scope of the disclosure.

In some examples, the node tags 113(1)-113(N) may include an NFC tag, radio-frequency identification (RFID) chips, quick response (QR) codes, bar codes, or any other identifier. The NFC tag may be encoded with node serial data. The mobile device 150 may determine whether a retrieval is out-of-order based on movement, such as movement sensed by an accelerometer within the mobile device 150.

In some examples, the node data retrieved from the node tags 113(1)-113(N) may provide an ability to determine status or health information at the mobile device 150 (e.g., either directly or via the administrator system 158), such as an upgrade in process, a maintenance request, a failure, etc. The administrator system 158, the mobile device 150, and/or the computing node 102(1)-102(N) may be configured to provide alerts, which may include indications of power failures, configuration errors, hardware errors, etc. Having relative physical location information may allow a user to troubleshoot a failure of a single computing node. For example, if a computing node is offline, status of adjacent computing nodes could be checked to determine whether it is isolated to a single computing node, or whether multiple of the computing nodes 102(1)-102(N) are affected. The alerts may provide computing node information and information indicating relative position among the computing nodes 102(1)-102(N).

The mobile device 150 may be capable of communicating with the computing nodes 102(1)-102(N) to cause the computing nodes 102(1)-102(N) to perform various operations, such as a reset, initiate a health check, cause the computing nodes 102(1)-102(N) to set, reconfigure, distribute a workload(s) (e.g., such as when a computing node has failed), or initiate a software upgrade, etc. In some examples, the workload re-distribution may be used to optimize power efficiency of the workloads in the computing system 100, and may include a VM migration, for example.

In some examples, the node data may include information indicating previous or current failures, a history of alerts, remedial or precautionary action taken, a recommended action to correct a failure, etc., or combinations thereof. The recommended action may include either or both of a permanent action or a temporary action. The temporary action may include an action for operating one or more of the computing nodes 102(1)-(N), such as operating a safe mode or limited mode intended to reduce a possibility of subsequent failures until the repairs are performed return to full functionality.

Status updates provided by the computing nodes 102(1)-102(N) may include updates when the rolling upgrade stalls, information regarding different versions of software updates for respective computing nodes 102(1)-102(N), whether the computing node has a working network connection, etc. A status update may be displayed on the mobile phone 150 or the administrator system 158 electrically coupled to the mobile device 150. The alerts may indicate a successful or an unsuccessful update. In some examples, the status updates and/or the alerts displayed on the mobile device 150 or the administrator system 158 may be color coded to indicate a type of alert or status update, such as green and red alerts for successful and unsuccessful updates, respectively, for the computing nodes 102(1)-102(N). An alert or status update may be selected to provide more information, in some examples, such as a time, a recommended follow-on action, network status, etc.

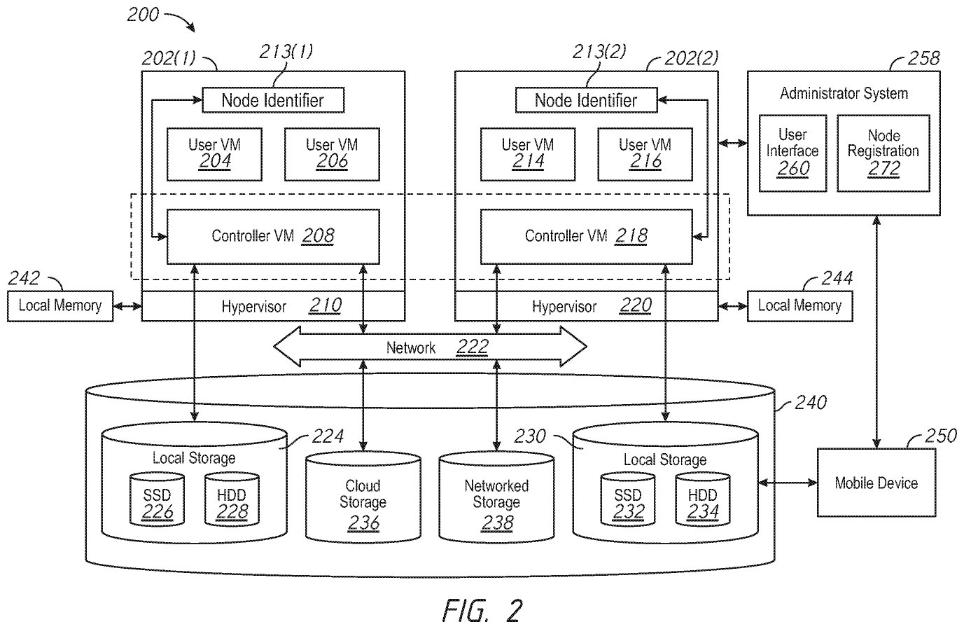

FIG. 2 is a block diagram of the computing system 200 arranged in accordance with examples described herein. The computing system 200 may include computing nodes 202(1) and 202(2) and the storage 240 connected to the network 222. The network 222 may be any type of network capable of routing data transmissions from one network device (e.g., the computing node 202(1), the computing node 202(2), and the storage 240) to another. For example, the network 222 may be a local area network (LAN), wide area network (WAN), intranet, Internet, or a combination thereof. The network 222 may be a wired network, a wireless network, or a combination thereof. The mobile device 250 and the computing nodes 202(1) and 202(2) may be implemented, respectively, in the mobile device 150 and any of the computing nodes 102(1)-(N) of FIG. 1.

The storage 240 may include the local storage 224, the local storage 230, the cloud storage 236, and the networked storage 238. The local storage 224 may include, for example, one or more SSDs 226 and one or more HDDs 228. Similarly, the local storage 230 may include the SSD 232 and the HDD 234. The local storage 224 and the local storage 230 may be directly coupled to, included in, and/or accessible by a respective computing node 202(1) and/or computing node 202(2) without communicating via the network 222. Other nodes, however, may access the local storage 224 and/or the local storage 230 using the network 222. The cloud storage 236 may include one or more storage servers that may be stored remotely to the computing node 202(1) and/or the computing node 202(2) and accessed via the network 222. The cloud storage 236 may generally include any type of storage device, such as HDDs SSDs, or optical drives. The networked storage 238 may include one or more storage devices coupled to and accessed via the network 222. The networked storage 238 may generally include any type of storage device, such as HDDs SSDs, or optical drives. In various embodiments, the networked storage 238 may be a storage area network (SAN). The computing node 202(1) is a computing device for hosting VMs in the distributed computing system according to the embodiment. The computing node 202(1) and 202(2) may be, for example, a server computer, a laptop computer, a desktop computer, a tablet computer, a smart phone, or any other type of computing device.

The computing node 202(1) and 202(2) may each include a respective node tag 213(1) and 213(2). The computing nodes 202(1) and 202(2) may further include processor(s), sensor(s) (e.g., fan speed sensors, temperature sensors), lights (e.g., one or more LEDs), memory devices, and/or disks. Local storage may in some examples include one or more of the computing nodes—such as local storage 224 and/or local storage 230.

The computing node 202(1) is configured to execute the hypervisor 210, the controller VM 208, and one or more user VMs, such as user VMs 204, 206. The user VMs including user VM 204 and user VM 206 are VM instances executing on the computing node 202(1). The user VMs including user VM 204 and user VM 206 may share a virtualized pool of physical computing resources such as physical processors and storage (e.g., storage 240). The user VMs including user VM 204 and user VM 206 may each have their own operating system, such as Windows or Linux. While a certain number of user VMs are shown, generally any number may be implemented. User VMs may generally be provided to execute any number of applications which may be desired by a user.

The hypervisor 210 may be any type of hypervisor. For example, the hypervisor 210 may be ESX, ESX(i), Hyper-V, KVM, or any other type of hypervisor. The hypervisor 210 manages the allocation of physical resources (such as storage 240 and physical processors) to VMs (e.g., user VM 204, user VM 206, and controller VM 218) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 208 and/or the controller VM 218, may provide services for the user VMs in the computing node. As an example of functionality that a controller VM may provide, the controller VM 208 may provide virtualization of the storage 240. Controller VMs may provide management of the distributed computing system according to the embodiment. Examples of controller VMs may execute a variety of software and/or may manage (e.g., serve) the I/O operations for the hypervisor and VMs running on that node. In some examples, a SCSI controller, which may manage SSD and/or HDD devices described herein, may be directly passed to the CVM, e.g., leveraging VM-Direct Path. In the case of Hyper-V, the storage devices may be passed through to the CVM.

The computing node 202(2) may include user VM 214, user VM 216, a controller VM 218, and a hypervisor 220. The user VM 214, user VM 216, the controller VM 218, and the hypervisor 220 may be implemented similarly to analogous components described above with respect to the computing node 202(1). For example, the user VM 214 and user VM 216 may be implemented as described above with respect to the user VM 204 and user VM 206. The controller VM 218 may be implemented as described above with respect to controller VM 208. The hypervisor 220 may be implemented as described above with respect to the hypervisor 210. The hypervisor 220 may be included the computing node 202(2) to access, by using a plurality of user VMs, a plurality of storage devices in a storage pool. In the embodiment of FIG. 2, the hypervisor 220 may be a different type of hypervisor than the hypervisor 210. For example, the hypervisor 220 may be Hyper-V, while the hypervisor 210 may be ESX(i).

Controller VMs, such as the controller VM 208 and the controller VM 218, may each execute a variety of services and may coordinate, for example, through communication over network 222. Namely, the controller VM 208 and the controller VM 218 may communicate with one another via the network 222. By linking the controller VM 208 and the controller VM 218 together via the network 222, a distributed network of computing nodes including computing node 202(1) and computing node 202(2), can be created.

Services running on controller VMs may utilize an amount of local memory to support their operations. For example, services running on the controller VM 208 may utilize memory in local memory 242. Services running on the controller VM 218 may utilize local memory 244. The local memory 242 and the local memory 244 may be shared by VMs on computing node 202(1) and computing node 202(2), respectively, and the use of the local memory 242 and/or the local memory 244 may be controlled by hypervisor 210 and hypervisor 220, respectively. Moreover, multiple instances of the same service may be running throughout the distributed system—e.g., a same services stack may be operating on each controller VM. For example, an instance of a service may be running on the controller VM 208 and a second instance of the service may be running on the controller VM 218.

Generally, controller VMs described herein, such as the controller VM 208 and the controller VM 218 may be employed to control and manage any type of storage device, including all those shown in the storage 240 of FIG. 2, including the local storage 224 (e.g., SSD 226 and HDD 228), the cloud storage 236, and the networked storage 238. Controller VMs described herein may implement storage controller logic and may virtualize all storage hardware as one global resource pool (e.g., storage 240) that may provide reliability, availability, and performance. IP-based requests are generally used (e.g., by user VMs described herein) to send I/O requests to the controller VMs. For example, the user VM 204 and the user VM 206 may send storage requests the controller VM 208 using an IP request. Controller VMs described herein, such as the controller VM 208, may directly implement storage and I/O optimizations within the direct data access path.

Note that controller VMs are provided as virtual machines utilizing hypervisors described herein—for example, the controller VM 208 is provided behind the hypervisor 210. Since the controller VMs running “above” the hypervisors examples described herein may be implemented within any virtual machine architecture, the controller VMs may be used in conjunction with generally any hypervisor from any virtualization vendor.

Virtual disks (vDisks) may be structured from the storage devices in storage 240, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 208 may expose one or more vDisks of the storage 240 and may mount a vDisk on one or more user VMs, such as user VM 204 and/or user VM 206.

During operation, user VMs (e.g., user VM 204 and/or user VM 206) may provide storage input/output (I/O) requests to controller VMs (e.g., the controller VM 208 and/or the hypervisor 210). Accordingly, a user VM may provide an I/O request to a controller VM as an iSCSI and/or NFS request. Internet Small Computer System Interface (iSCSI) generally refers to an IP-based storage networking standard for linking data storage facilities together. By carrying SCSI commands over IP networks, iSCSI can be used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. NFS refers to an IP-based file access standard in which NFS clients send file-based requests to NFS servers via a proxy folder (directory) called “mount point”. Generally, then, examples of systems described herein may utilize an IP-based protocol (e.g., iSCSI and/or NFS) to communicate between hypervisors and controller VMs.

During operation, user VMs described herein may provide storage requests using an IP based protocol. The storage requests may designate the IP address for a controller VM from which the user VM desires I/O services. The storage request may be provided from the user VM to a virtual switch within a hypervisor to be routed to the correct destination. For examples, the user VM 204 may provide a storage request to hypervisor 210. The storage request may request I/O services from the controller VM 208 and/or the controller VM 218. If the request is to be intended to be handled by a controller VM in a same service node as the user VM (e.g., the controller VM 208 in the same computing node as user VM 204) then the storage request may be internally routed within computing node 202(1) to the controller VM 208. In some examples, the storage request may be directed to a controller VM on another computing node. Accordingly, the hypervisor (e.g., hypervisor 210) may provide the storage request to a physical switch to be sent over a network (e.g., network 222) to another computing node running the requested controller VM (e.g., computing node 202(2) running the controller VM 218).

Accordingly, controller VMs described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks.

Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

Examples of systems described herein may include one or more administrator systems, such as administrator system 258 of FIG. 2. The administrator system 258 may be implemented using, for example, one or more computers, servers, laptops, desktops, tablets, mobile phones, or other computing systems. In some examples, the administrator system 258 may be wholly and/or partially implemented using one of the computing nodes of a distributed computing system described herein. However, in some examples (such as shown in FIG. 2), the administrator system 258 may be a different computing system from the virtualized system and may be in communication with a CVM of the virtualized system (e.g., controller VM 208 of FIG. 2) using a wired or wireless connection (e.g., over a network).

Administrator systems described herein may include executable instructions for node registration 272 and may host one or more user interfaces, e.g., user interface 260. The user interface may be implemented, for example, by displaying a user interface on a display of the administrator system 258. The user interface 260 may receive input from one or more users (e.g., administrators) using one or more input device(s) of the administrator system, such as, but not limited to, a keyboard, mouse, touchscreen, and/or voice input. The user interface 260 may provide an input to controller VM 208. The input may be used to provide a command for and/or a location of computing nodes corresponding to node identifiers associated with the respective node tags described herein. The input may identify one or more computing nodes to control based on the node identifier(s).

The user interface 260 may be implemented, for example, using a web service provided by the controller VM 208 or one or more other controller VMs described herein. In some examples, the user interface 260 may be implemented using a web service provided by controller VM 208 and information from controller VM 208 may be provided to controller VM 208 for display in the user interface 260.

Examples of systems described herein may include one or more mobile devices, such as a mobile device 250 of FIG. 2. The mobile device 250 may be implemented using, for example, one or more laptops, tablets, mobile phones, or other portable computing systems. In some examples, the mobile device 250 may be wholly and/or partially implemented using one of the computing nodes of a distributed computing system described herein. However, in some examples, the mobile device 250 may be a different computing system from the computing nodes 202 of the virtualized system and may be in communication with a local storage (e.g., local storage 230 of FIG. 2), and may be in communication with a CVM of the virtualized system (e.g., controller VM 208 of FIG. 2) using a wired or wireless connection (e.g., over a network).

In operation, the mobile device 250 may retrieved node data from the computing nodes 202(1) and 202(2) via the node tags 213(1) and 213(2). The mobile device 250 may receive node data from the computing nodes 202(1) and 202(2) by tapping the mobile device 250 near one of the respective node tags 213(1) and 213(2), scanning the respective node tags 213(1) and 213(2), initiating an RFID communication with the respective node tags 213(1) and 213(2), pairing with the respective node tags 213(1) and 213(2), etc. The node data may include a node identifier. In some examples, the node data may further include alerts, status information, configuration information, etc., or combinations thereof.

In one example, retrieval of the node data by the mobile device 250 may be to facilitate mapping of physical locations of the computing nodes 202(1) and 202(2) relative to one another within a server rack. The mapping may be in response to a registration request from the instructions for node registration 272 of the administrator system 258, or in response to a user input received at the mobile device 250. The mobile device 250 may provide prompts and/or instructions to a user to retrieve node data associated with each of the computing nodes 202(1) and 202(2). The mobile device 250 may retrieve node data from the node tags 213(1) and 213(2) of computing nodes 202(1) and 202(2). In some examples, an order in which the node data is retrieved from the computing nodes 202(1) and 202(2) may be specified (e.g., via instructions or a prompt displayed on the mobile phone 150), predetermined (e.g., based on a previous order), or may be based on some other criteria. The order may include a top-to-bottom scan, a bottom-to-top scan, a right-to-left scan, a left-to-right scan, or any combination thereof. When node data is retrieved from the computing nodes 202(1) and 202(2) in an order that is different than an expected order, the mobile device 150 may provide an alert indicating an out-of-order scan. In response to determining that node data retrieved from the respective node tag 213(1) and 213(2) of the computing node 202(1) and 202(2) complies with the particular order, adding the respective node data received via the respective node tag 213(1) and 213(2) to server rack node information. The server rack node information may be provided to the administrator system 258 by the mobile phone 250, either after every scan, or collectively after a scan of all of the computing nodes 202(1) and 202(2) is complete.

In some examples, the node tags 213(1) and 213(2) may include an NFC tag, radio-frequency identification (RFID) chips, quick response (QR) codes, bar codes, or any other identifier. The NFC tag may be with encoded block serial data. The mobile device 250 may determine whether a retrieval is out-of-order based on movement, such as movement sensed by an accelerometer within the mobile device 250.

To identify and map the physical locations of the computing nodes 202(1) and 202(2) relative to one another, the mobile device 250 may display instructions to direct a user on a procedure to scan the node tags 213(1) and 213(2). The instructions may include provision of a scan order or direction, which may be based on a physical orientation of the computing nodes 202(1) and 202(2) relative to one another (e.g., vertically-oriented, horizontally-oriented, etc.). To scan one of the node tags 213(1) and 213(2), a user may physically move the mobile device 250 immediately proximate to the node tag. Once a scan is complete, the user may physically move the mobile device 250 immediately proximate to the other of the node tags 213(1) and 213(2). The specific scanning method may be based on the type of node tag. For example, if the node tags 213(1) and 213(2) are NFC devices, the mobile phone 250 may scan based on close proximity using near-field RF signals. If the node tags 213(1) and 213(2) are RFID devices, the mobile phone 250 may scan by directing an RFID beam at the node tags 213(1) and 213(2) in close proximity and receiving a response. If the node tags 213(1) and 213(2) are QR or other codes, the mobile phone 250 may scan using a camera or other optical sensor.

The mobile device 250 may direct the user to scan the node tags 213(1) and 213(2) in a particular order, one by one. When the mobile device 250 is moved from one of the node tags 213(1) and 213(2) to a next node tag, the mobile device 250 may track physical movement of the mobile device 250 using accelerometer data. If the mobile device 250 detects that the next scan conflicts with the particular order, an alert may be displayed. For example, if the particular order is vertically from top-to-bottom and the accelerometer data indicates that the mobile device 250 moved upward vertically from a previous scan, the mobile device 250 may provide an alert. In some examples, if an out-of-order scan is detected, the mobile device 250 may provide instructions to start the scan over.

In some examples, the node data retrieved from the node tags 213(1) and 213(2) may provide an ability to determine status or health information at the mobile device 250 (e.g., either directly based on communication with the controller VMs 208, 218, respectively, or via the administrator system 258), such as an upgrade in process, a maintenance request, a failure, etc. The administrator system 258, the mobile device 250, and/or the computing node 202(1) and 202(2) may be configured to provide alerts, which may include indications of power failures, configuration errors, hardware errors, etc. Having relative physical location information may allow a user to troubleshoot a failure of a single computing node. For example, if a computing node is offline, status of adjacent computing nodes could be checked to determine whether it is isolated to a single computing node, or whether multiple of the computing nodes 202(1) and 202(2) are affected. The alerts may provide computing node information and information indicating relative position among the computing nodes 202(1) and 202(2).

The mobile device 250 may be capable of communicating with the computing nodes 202(1) and 202(2) to cause the computing nodes 202(1) and 202(2) to perform various operations, such as a reset, initiate a health check, cause the computing nodes 202(1) and 202(2) to set, reconfigure, or distribute a workload(s) (e.g., such as when a computing node has failed), initiate a software upgrade, etc. In some examples, the workload re-distribution may be used to optimize power efficiency of the workloads in the computing system 100, and may include a VM migration, for example.

In some examples, the node data may include information indicating previous or current failures, a history of alerts, remedial or precautionary action taken, a recommended action to correct a failure, etc., or combinations thereof. The recommended action may include either or both of a permanent action or a temporary action. The temporary action may include an action for operating one or more of the computing nodes 202(1) and 202(2), such as operating a safe mode or limited mode intended to reduce a possibility of subsequent failures until the repairs are performed return to full functionality.

Status updates provided by the computing nodes 202(1) and 202(2) may include updates when the rolling upgrade stalls, information regarding different versions of software updates for respective computing nodes 202(1) and 202(2), whether the computing node has a working network connection, etc. A status update may be displayed on the mobile phone 250 or the administrator system 258 electrically coupled to the mobile device 250. The alerts may indicate a successful or an unsuccessful update. In some examples, the status update and/or the alerts displayed on the mobile device 250 or the administrator system 258 may be color coded to indicate a type of alert or status update, such as green and red alerts for successful and unsuccessful updates, respectively, for the computing nodes 202(1) and 202(2). An alert or status update may be selected to provide more information, in some examples, such as a time, a recommended follow-on action, network status, etc.

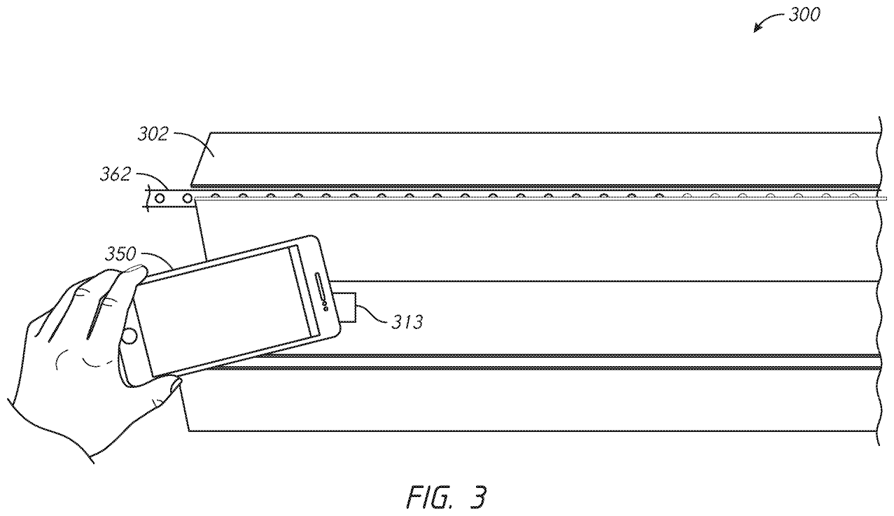

FIG. 3 is a computing system 300 including a mobile device 350 and a computing node 302 arranged in accordance with examples described herein. The computing node 302 includes a node tag 313. The mobile device 350 and the computing node 302 may be implemented, respectively, as the mobile device 150 and any of the computing nodes 102(1)-(N) of FIG. 1 and/or the mobile device 250 and either of the computing nodes 202(1) or 202(2) of FIG. 2. The node tag 313 may be implemented in any of the node tags 113(1)-(N) of FIG. 1 and/or either of the node tags 213(1) or 213(2) of FIG. 2.

The mobile device 350 may be positioned (e.g., placed or held) in front of the computing node 302 to scan the node tag 313 of the computing node 302 to retrieve node data. The node tag 313 may include a NFC tag, radio-frequency identification (RFID) chips, quick response (QR) codes, bar codes, or any other identifier. The mobile device 350 uses the node data to provide information for a user (e.g., technician) to provide node identification information, such as during registration, and/or status information associated with the computing node 302.

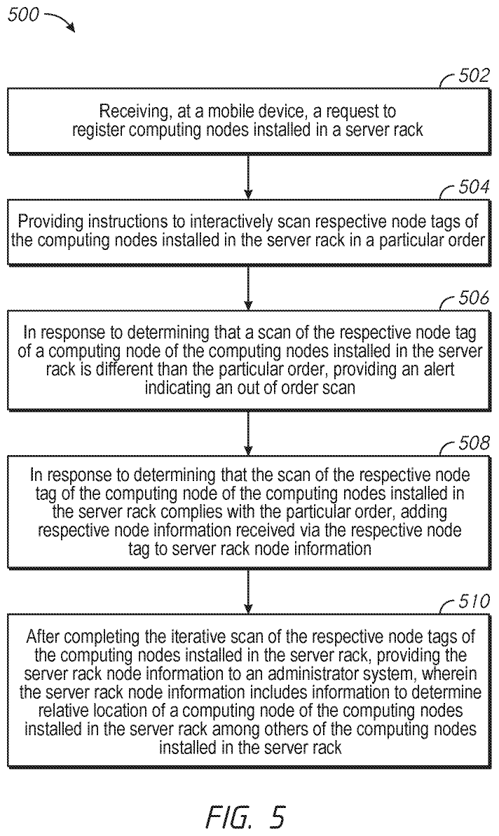

FIG. 5 is a flow diagram of a method for computing node registration and mapping relative location within a server rack according to an embodiment. The method 500 may be performed by the computing system 100 of FIG. 1, the computing system 200 of FIG. 2, the computing system 300 of FIG. 3, or combinations thereof.

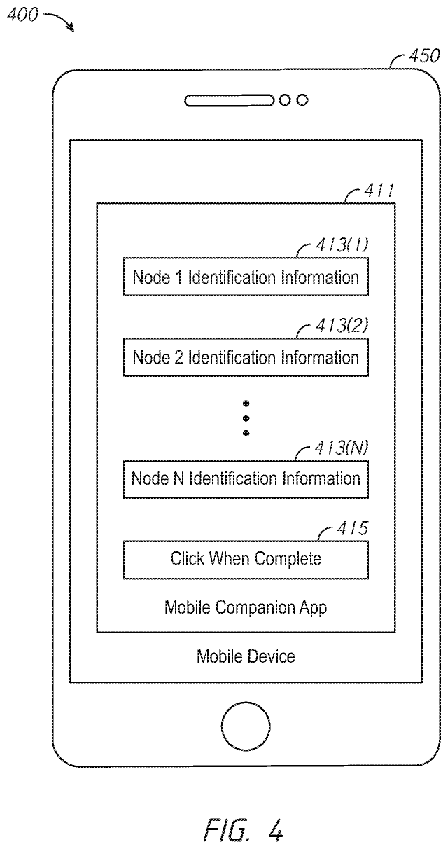

The method 500 may include receiving, at a mobile device, a request to register computing nodes installed in a server rack, at 502. In some examples, the method 500 may include providing instructions to iteratively scan respective node tags of the computing nodes installed in the server rack in a particular order, at 504. The server rack, computing nodes, and mobile device may be implemented, respectively, by the server rack 101, the computing nodes 102(1)-102(N), and the mobile device 150 of FIG. 1. The computing nodes and mobile device may be implemented, respectively, by the computing nodes 202(1) and 202(2) and the mobile device 250 of FIG. 2. The computing nodes may be each implemented by the computing node 302 of FIG. 3. The mobile device of FIG. 5 may be implemented, respectively, by the mobile device 450 of FIG. 4.

In some examples, the method 500 may include, in response to determining that a scan of the respective node tag of a computing node of the computing nodes installed in server rack is different than the particular order, providing an alert indicating an out of order scan, at 506.

In some examples, the method 500 may include, in response to determining that the scan of the respective node tag of the computing node of the computing nodes installed in server rack complies with the particular order, adding respective node information received via the respective node tag to server rack node information, at 508.

In some examples, the method 500 may include, after completing the iterative scan of the respective node tags of the computing nodes installed in the server rack, providing the server rack node information to the administrator system, at 510. The server rack node information includes information to determine relative location of a computing node of the computing nodes installed in the server rack among others of the computing nodes installed in the server rack.

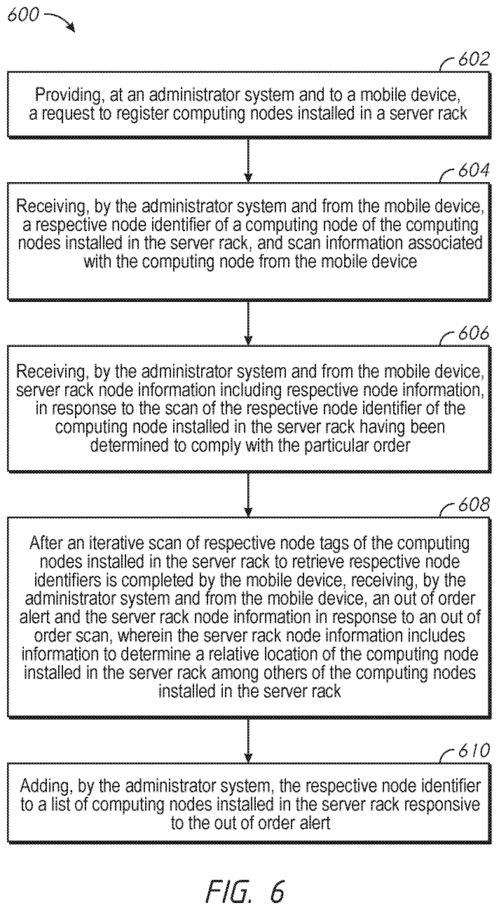

FIG. 6 is a flow diagram of a method for computing node registration and mapping within a server rack in accordance with embodiments described herein. The method 600 may be performed by the computing system 100 of FIG. 1, the computing system 200 of FIG. 2, or combinations thereof.

The method 600 may include providing, at an administrator system and to a mobile device, a request to register computing nodes installed in a server rack, at 602. In some examples, the method 600 may include receiving, by the administrator system and from the mobile device, a respective node tag of a computing node of the computing nodes installed in the server rack, and scan information associated with a computing node of the computing nodes from the mobile device, at 604. The server rack, computing nodes, and mobile device may be implemented, respectively, by the server rack 101, the computing nodes 102(1)-102(N), and the mobile device 150 of FIG. 1. The computing nodes and mobile device may be implemented, respectively, by the computing nodes 202(1) and 202(2) and the mobile device 250 of FIG. 2. The computing nodes may be each implemented by the computing node 302 of FIG. 3. The mobile device of FIG. 6 may be implemented, respectively, by the mobile device 450 of FIG. 4.

In some examples, the method 600 may include receiving, by the administrator system and from the mobile device, server rack node information including respective node information, in response to the scan of the respective node tag of the computing node of the computing nodes installed in the server rack having been determined to comply with the particular order, at 606.

In some examples, the method 600 may include, after the iterative scan of the respective node tags of the computing nodes installed in the server rack is completed by the mobile device, receiving, by the administrator system and from the mobile device, an out of order alert and the server rack node information in response to an out of order scan, at 608. The server rack node information includes information to determine a relative location of a computing node of the computing nodes installed in the server rack among others of the computing nodes installed in the server rack.

In some examples, the method 600 may include adding, by the administrator system, the respective node tag to a list of computing nodes installed in the server rack responsive to the out of order alert, at 610.

From the foregoing it will be appreciated that, although specific embodiments have been described herein for purposes of illustration, various modifications may be made while remaining with the scope of the claimed technology.

1. An apparatus comprising:
a display;
a transceiver; and
a processor configured to:
receive, from the transceiver, a request to register computing nodes installed in a server rack;
add, in response to determining that a scan of a respective node tag of a computing node of the computing nodes installed in the server rack complies with a particular order, respective node information received via the respective node tag to server rack node information; and
after completing an iterative scan of the respective node tags of the computing nodes installed in the server rack, provide the server rack node information to an administrator system, wherein the server rack node information includes location information of the computing node relative to remaining ones of the computing nodes.

2. The apparatus of claim 1, wherein the processor is further configured to display, at the display, upgrade information regarding an upgrade required for the computing node.

3. The apparatus of claim 2, wherein the processor is further configured to receive, at the transceiver, power outage information from the computing node.

4. The apparatus of claim 1, wherein the scan of the respective node tag of the computing node is performed by a mobile device when the mobile device is moved toward the computing node such that a distance between the mobile device and the computing node is less than a threshold distance.

5. The apparatus of claim 1, wherein the processor is further configured to:
identify characteristics of a malfunction of the computing node and determine a cause of the malfunction.

6. The apparatus of claim 1, wherein the processor is further configured to initiate an upgrade of the computing node, and display, at the display, a progress bar regarding a status of the upgrade.

7. The apparatus of claim 1, wherein the processor is further configured to:
receive characteristics of each of the computing nodes, and
display, at the display, a first upgrade indicator corresponding to computing nodes previously upgraded.

8. The apparatus of claim 1, wherein the processor is further configured provide, by the transceiver, a low priority indicator when a single computing node of the computing nodes has failed.

9. The apparatus of claim 8, wherein the processor is further configured to display, at the display, at least one suggested remedy of a plurality of suggested remedies when a single computing node of the computing nodes has failed.

10. The apparatus of claim 1, wherein the processor is further configured to identify that an upgrade is required for the computing node and display an indicator for performing a one click upgrade of the computing node.

11. The apparatus of claim 1, wherein the scan of the respective node tag of the computing node is performed using a near field communication (NFC) tag, a radio frequency identification (RFID) chip, or a quick response (QC) code.

12. A method comprising:
receiving, at a mobile device, a request to register a computing node installed in a server rack;
providing instructions to iteratively scan respective node tags of computing nodes, including the computing node, installed in the server rack in a particular order;
in response to determining that a scan of the respective node tag of the computing node of the computing nodes installed in the server rack is different than the particular order, providing an alert indicating an out of order scan;
in response to determining that the scan of the respective node tag of the computing node of the computing nodes installed in the server rack complies with the particular order, adding respective node information received via the respective node tag to server rack node information; and
after completing the iterative scan of the respective node tags of the computing nodes installed in the server rack, providing the server rack node information to an administrator system, wherein the server rack node information includes information to determine relative location of a computing node of the computing nodes installed in the server rack among others of the computing nodes installed in the server rack.

13. The method of claim 12, further comprising receiving the respective node tag responsive to the mobile phone tapping the computing node.

14. The method of claim 12, further comprising displaying, on the mobile device, a plurality of identification symbols corresponding, respectively, to a plurality of node tags.

15. The method of claim 12, wherein an order of the plurality of identification symbols displayed on the mobile device is the same as an order of the plurality of respective node tags, respectively.

16. The method of claim 12, further comprising displaying, on the mobile device, at least one alert associated with at least one computing node of the computing nodes, respectively.

17. The method of claim 12, further comprising displaying, on the mobile device, at least one status identifier including information regarding at least one computing node of the computing nodes, respectively.

18. The method of claim 12, wherein the scan of the respective node tag of the computing node is performed by using a near field communication (NFC) tag, a radio frequency identification (RFID) chip, or a quick response (QC) code.

19. A method comprising:
providing, at an administrator system and to a mobile device, a request to register a computing node of a plurality of computing nodes installed in a server rack;
receiving, by the administrator system and from the mobile device, a respective node identifier of the computing node of the plurality of computing nodes installed in the server rack, and scan information associated with the computing node from the mobile device;
receiving, by the administrator system and from the mobile device, server rack node information including respective node information, in response to the scan of the respective node identifier of the computing node installed in the server rack having been determined to comply with the particular order;
after an iterative scan of respective node tags of the plurality of computing nodes installed in the server rack to retrieve respective node identifiers is completed by the mobile device, receiving, by the administrator system and from the mobile device, an out of order alert and the server rack node information in response to an out of order scan, wherein the server rack node information includes information to determine a relative location of the computing node installed in the server rack among others of the plurality of computing nodes installed in the server rack; and
adding, by the administrator system, the respective node identifier to a list of computing nodes installed in the server rack responsive to the out of order alert.

20. The method of claim 19, further comprising receiving, by the administrator system and from the mobile device, a notification of at least one of a shutdown signal, a maintenance mode signal, and a reset signal sent to the computing node associated with the respective node identifier added to the list of computing nodes in the server rack responsive to the out of order alert.

21. The method of claim 19, further comprising receiving, by the administrator system and from the mobile device, an operating parameters control signal responsive to receiving the server rack node information, wherein the operating parameters received via the control signal include workload distribution parameters of the computing nodes.

22. The method of claim 19, further comprising:
receiving, by the administrator system and from the mobile device, a determination of a cause of a malfunction of the computing node responsive to receiving the server rack node information.

23. The method of claim 19, wherein the scan of the respective node tag of the computing node to retrieve the respective node identifier is performed by using a near field communication (NFC) tag, a radio frequency identification (RFID) chip, or a quick response (QC) code.

24. The apparatus of claim 1, wherein the processor is further configured to:
provide, in response to determining that the scan of the respective node tag of the computing node of the computing nodes installed in the server rack is different than the particular order, an alert indicating an out of order scan.

25. The apparatus of claim 5, wherein the processor is further configured to:
display, at the display, a list of recommended corrective actions corresponding to the determined cause of the malfunction.

26. The apparatus of claim 7, wherein the processor if further configured to:
display, at the display, a second upgrade indicator corresponding to computing nodes not previously upgraded.

27. The apparatus of claim 7, wherein the processor is further configured to:
display, at the display, a third upgrade indicator corresponding to computing nodes partially upgraded and hung.

28. The apparatus of claim 1, wherein the processor is further configured to:
provide, by the transceiver, a high priority indicator when more than one computing node of the computing nodes has failed.

29. The apparatus of claim 28, wherein the processor is further configured to:
control the display to display a second plurality of suggested remedies when more than one computing node of the computing nodes has failed.

30. The method of claim 22, further comprising:
receiving, by the administrator system and from the mobile device, a remedial action control signal associated with the determined malfunction of the computing node.

31. The method of claim 30, wherein the remedial action control signal includes at least one recommended remedial action of the mobile device configured to correct the malfunction of the computing node and set the computing node in normal operating mode.

32. At least one non-transitory computer readable medium encoded with instructions which, when executed, cause a mobile device to perform actions comprising:
receiving a request to register computing nodes installed in a server rack;
providing instructions to iteratively scan respective node tags of the computing nodes installed in the server rack in a particular order;
in response to determining that a scan of the respective node tag of a computing node of the computing nodes installed in the server rack is different than the particular order, providing an alert indicating an out of order scan;
in response to determining that the scan of the respective node tag of the computing node of the computing nodes installed in the server rack complies with the particular order, adding respective node information received via the respective node tag to server rack node information; and
after completing the iterative scan of the respective node tags of the computing nodes installed in the server rack, providing the server rack node information to an administrator system, wherein the server rack node information includes information to determine relative location of a computing node of the computing nodes installed in the server rack among others of the computing nodes installed in the server rack.

33. The non-transitory computer readable medium of claim 32, the actions further comprising:
receiving the respective node tag responsive to the mobile device tapping the computing node.

34. The non-transitory computer readable medium of claim 32, the actions further comprising:
displaying a plurality of identification symbols corresponding, respectively, to a plurality of node tags.

35. The non-transitory computer readable medium of claim 34, wherein an order of the plurality of identification symbols displayed is the same as an order of the plurality of respective node tags, respectively.

36. The non-transitory computer readable medium of claim 32, the actions further comprising:
displaying at least one alert associated with at least one computing node of the computing nodes, respectively.

37. The non-transitory computer readable medium of claim 32, the actions further comprising:
displaying at least one status identifier including information regarding at least one computing node of the computing nodes, respectively.

38. The non-transitory computer readable medium of claim 32, wherein the scan of the respective node tag of the computing node is performed by using a near field communication (NFC) tag, a radio frequency identification (RFID) chip, or a quick response (QC) code.
